(19) United States
(12) Patent Application Publication
(10) Pub. No.: US 2011/0185895 A1
(43) Pub. Date: Aug. 4, 2011

(54) FILTER APPARATUS AND METHOD OF MONITORING FILTER APPARATUS

(76) Inventor: PAUL FREEN, Titusville, FL (US)

(21) Appl. No.: 13/020,646

(22) Filed: Feb. 3, 2011

Related U.S. Application Data
(60) Provisional application No. 61/337,388, filed on Feb. 3, 2010.

(51) Int. Cl. B01D 46/42; G01N 15/08

(52) U.S. Cl. 95/25; 96/421; 73/38

(57) ABSTRACT

Methods, systems, and products for monitoring an air filter. Methods involve determining a difference between a baseline pressure differential and a current pressure differential, the differential pressure between pressure at an upstream side of the filter and pressure at a downstream side of the filter. The baseline pressure differential may be set automatically or by a user. Reaching or exceeding a predetermined threshold triggers an indication of a clogged condition. The method also includes monitoring the air filter condition intermittently. The filter monitor may operate for extended periods in a sleep state and intermittently power up to a wake state to measure the current pressure differential and compare the current pressure differential with a baseline pressure differential.

The present application claims the benefit of, and priority to, the filing date of U.S. Provisional Application Ser. No. 61/337,388, filed on Feb. 3, 2010 (pending). The disclosure is hereby incorporated by reference for all purposes and made a part of the present disclosure.

### BACKGROUND

The present invention relates to systems, methods, and apparatus for monitoring filter media, particularly an air filter.

Air filters may be employed in a variety of internal flow systems to remove undesireable substances and matter from the flow stream. The present invention is particularly suited for use with air filters employed in heating, ventilating, and air conditioning (‘HVAC’) systems. The air filter is placed in the flow stream generated by the HVAC system, typically near the inlet of the HVAC system. With the air flow directed through the filter media, the filter removes dust, debris, and other impurities from the flow stream (and from the space being serviced (“conditioned space”)). The filter media of even a new or clean air filter presents some resistance to the air flow, which translates to a pressure loss or head loss (i.e., the pressure differential across the filter) of a magnitude dependent, among other things, on the flow restriction and the velocity of the air flow. For clean filters, the pressure loss can be tolerated, as the benefits from filtration outweigh the system costs. As the porous filter media accumulates impurities, however the filter media further restricts air flow and the pressure loss across the filter increases. Among other things, the filter may lose some capacity or efficiency in filtering the air flow. The excess pressure loss may also represent significant energy loss in the HVAC system and result in a higher burden on system equipment. The pressure and energy losses also translate to a reduction m the efficiency and capacity of the HVAC system to cool or heat the conditioned space.

It is, therefore, good practice to replace the filter (or, possibly, clean the filter media) at some point (or at some condition of the filter) when the accumulation of filtered matter in the filter media begins to significantly impact the HVAC system's performance. This target condition may be indicated directly by observation of an excess amount of accumulation of filtered matter on the filter or, just as directly, a significant increase in the pressure differential across the filter. Such methods of “monitoring” become ineffective, however, if the user (maintenance personnel, homeowner, etc.) fails to periodically and diligently monitor HVAC performance or simply fail to recognize that a filter condition warrants cleaning or replacement. Prior art remote or automatic pressure using devices have been employed to aid in monitoring and maintenance. Many of these prior art devices have, however, proven cumbersome or difficult to use and often are rendered useless without initiative from the user. Other devices may be effective in specific filtering applications, but may be too expensive for broader applications.

### SUMMARY OF THE INVENTION

In one aspect of the invention, an apparatus is provided for monitoring a pressure differential across an air filter in a given internal flow stream, the flow stream having a grille frame positioned upstream of the filter. The apparatus includes a pressure sensing module for providing a differential pressure measurement across filter media of the air filter, a housing supporting the pressure sensing module, and a pressure sensing probe in communication with the pressure sensing module. The probe includes an elongated probe body that is adapted for insertion through a filter media and has a pressure sensing port therethrough. The probe is supported by the housing such that the probe body extends from inside the housing outwardly to a distal end. The apparatus further includes a base mount positionable on a grille frame upstream of the air filter. The housing is detachably engageable with the base mount to place the probe body in fluid communication with a pressure sensing location spaced from the opposite side of the base mount.

In one aspect of the invention, a method of monitoring involves comparing a baseline pressure differential with a current pressure differential. In one general embodiment, the method comprises calculating the difference between the baseline pressure differential and the current pressure differential. The baseline pressure differential may be set automatically or set by a user when the filter is new (e.g., when first installed). For example, the user may press a reset pushbutton on a device embodiment of the present invention immediately after installing a new filter. Setting the baseline pressure differential may include storing a value in a data structure. In further embodiments, the change in pressure differential or measured value may be calculated and stored as a percentage increase.

In further aspects of the invention, the system and method involve monitoring the air filter condition intermittently. The filter monitor may operate for extended periods in a sleep state. The monitor may intermittently power up to a wake state. While in the wake state the monitor may measure the current pressure differential and compare the current pressure differential with a baseline pressure differential.

Embodiments of the invention include methods of monitoring an air filter with a battery-powered filter monitor, where the system filters intake air flowing from an upstream to a downstream side of the filter. Methods may include determining with the filter monitor a first pressure differential between a first air pressure upstream of the filter and a second air pressure downstream of the filter; setting a baseline value at the first pressure differential; allowing extended operation of the filter monitor in a sleep state; intermittently waking the filter monitor, and returning the filter monitor to the sleep state. Intermittently waking the filter monitor may be carried out by powering up the filter monitor to a wake state; determining with the filter monitor a second pressure differential between the first air pressure upstream of the filter and the second air pressure downstream of the filter; determining the difference between the second pressure differential and the baseline value; and upon the difference between the second pressure differential and the baseline value exceeding a threshold value, indicating a clogged or target condition associated with the threshold value.

Other embodiments may include a controller for controlling a battery-powered filter monitor for monitoring an air filter. The controller may include determination circuits configured to determine with the filter monitor a first pressure differential between a first air pressure upstream of the filter and a second air pressure downstream of the filter; baseline circuits configured to set a baseline value at the first pressure differential; and power management circuits. The power management circuits may be configured to allow extended operation of the filter monitor in a sleep state, intermittently wake the filter monitor, and return the filter monitor to the sleep state. Intermittently waking the filter monitor may include powering up the filter monitor to a wake state; determining with the filter monitor a second pressure differential between the first air pressure upstream of the filter and the second air pressure downstream of the filter; and determining the difference between the second pressure differential and the baseline value. The power management circuits may include further circuits such as programmed logic circuits and interface circuits. The programmed logic circuits may be configured to indicate a clogged condition associated with the threshold value in response to the difference between the second pressure differential and the baseline value exceeding a threshold value. The controller may also include a memory for storing the baseline value. The controller may also include reset circuits configured to tugger the determination circuits in response to receiving an initiation signal.

The programmed logic circuit may be operatively connected with the switchable power circuit, the control interface, and at least one of the differential pressure module and the first and/or second air pressure sensors. The programmed logic circuit may be adapted to intermittently power up the apparatus from a sleep state for a measurement including activating the switchable power circuit, and power down the apparatus to the sleep state following the measurement including deactivating the switchable power circuit; receive the differential pressure signal; determine a current differential pressure value from the differential pressure signal; and if the apparatus is operating in a configuration mode, store the current differential pressure value as a baseline value; and if the apparatus is operating in a monitoring mode, calculate a difference between the baseline value and the current differential pressure value, and, upon the difference exceeding a threshold value, indicate a clogged condition corresponding to the threshold value through the control interface.

Upon receiving electric power after insertion of the probe, the differential pressure module measures a first air pressure at the location of the differential pressure transducer upstream of the filter and a second air pressure at the location of a sensor downstream of the filter, and the differential pressure signal indicates the difference between the first air pressure and the second air pressure.

In other embodiments, the apparatus comprises a differential pressure transducer adapted to, upon receiving electric power, generate a differential pressure signal representative of a differential pressure value, and a probe. The probe may include a probe body adapted for insertion of the probe through a filter and an opposing end connected to the differential pressure transducer. The probe may also include a port in the probe body in fluid communication with the probe exterior. The port may be adapted so that, upon complete insertion of the probe through the filter from the upstream side of the filter, the port is a sufficient distance from the opposing end of the probe for the port to be on a downstream side of the filter. The probe may include a passage extending along the interior of the probe body from the opposing end to the port This passage may link the differential pressure transducer and the port together, so that the differential pressure transducer measures a first air pressure at the location of the differential pressure transducer upstream of the filter and a second air pressure at the location of the port downstream of the filter.

Other embodiments of the present invention include a design structure embodied in a machine readable storage medium for at least one of designing, manufacturing, and testing a design. The design structure may include the controller for monitoring an air filter with a battery-powered filter monitor, as described above, constituent modules or circuits thereof, or constituent modules or circuits of the apparatus. The design structure may include a netlist which describes the controller, apparatus, or constituent modules or circuits. The design structure may reside on the machine readable storage medium as a data format used for the exchange of layout data of integrated circuits.

Other embodiments of the present invention include computer program products embodied in one or more computer readable media having computer readable program code disposed thereon. These computer program products may include computer program code adapted to carry out the methods of the present invention on a data processing system (computer).

### BRIEF DESCRIPTION OF THE DRAWINGS

The following figures are part of the present specification, included to demonstrate certain aspects of embodiments of the present disclosure and referenced in the detailed description herein.

FIG. 1 is a simplified schematic diagram of a filter monitoring device incorporated with an HVAC system, in accordance with embodiments of the present invention;

FIG. 2 is a simplified diagram illustrating an HVAC air handler with the filter monitoring device in FIG. 1 installed therein, in accordance with embodiments of the present invention;

FIGS. 3A-F are multiple views of a filter monitoring device and its various components, in accordance with embodiments of the present invention;

FIG. 4 is a detail view of the filter monitoring device installation in FIG. 3;

FIG. 5 is a simplified schematic illustrating a filter monitoring device in accordance with embodiments of the present invention;

FIG. 6 is a flow chart illustrating programming modules of the filter monitoring device, in accordance with the embodiments of the present invention;

FIGS. 7A-C are simplified illustrations of a filter monitor coupled through wireless communication in accordance with embodiments of the present invention; and

FIG. 8 is a simplified flow chart illustrating one exemplary method of monitoring an air filter or HVAC system according to the present invention.

### DETAILED DESCRIPTION

The principles of the invention are explained by describing in detail, specific and exemplary embodiments of devices, products, and methods for monitoring an HVAC air filter. Those skilled in the art will understand, however, that the invention may be embodied as many other devices, products, and methods. For example, various aspects of the methods and devices may be applied to other filter media and the maintenance of such other filter media. The scope of the invention is not intended to be limited by the details of exemplary embodiments described herein. The scope of the invention should be determined through study of the appended claims.

Embodiments of the disclosure include a device or apparatus for monitoring an operating condition of an HVAC filter and being responsive to the presence or arrival of a target filter condition. The condition of the HVAC filter is directly correlated to its efficiency in filtering air flowing through the HVAC system and the efficiency of the HVAC system to pass and treat conditioned air. The target filter condition is typically associated with a filter media that is clogged or heavily burdened by dust, debris, and other impurities, and through which the HVAC flow stream incurs a significant pressure chop. The target filter condition may also represent an undesirable reduction in the efficiency of the filter to filter air flow and the HVAC system to heat or cool the conditioned space. In certain embodiments, the device monitors the change or difference in differential pressure across the filter. The target change or target differential pressure may be obtained from historical data, manufacturer's data, or other empirical data. The preferred device and method of monitoring provides, therefore, a means of determining a target condition of the filter based upon a change in the differential pressure readings from a baseline value(s) and an actual or measured value(s). More preferably, the filter monitoring device responds to the detection of a target condition by way of a target change in differential pressure (and determining the presence of the target condition) by initiating an alert or alarm.

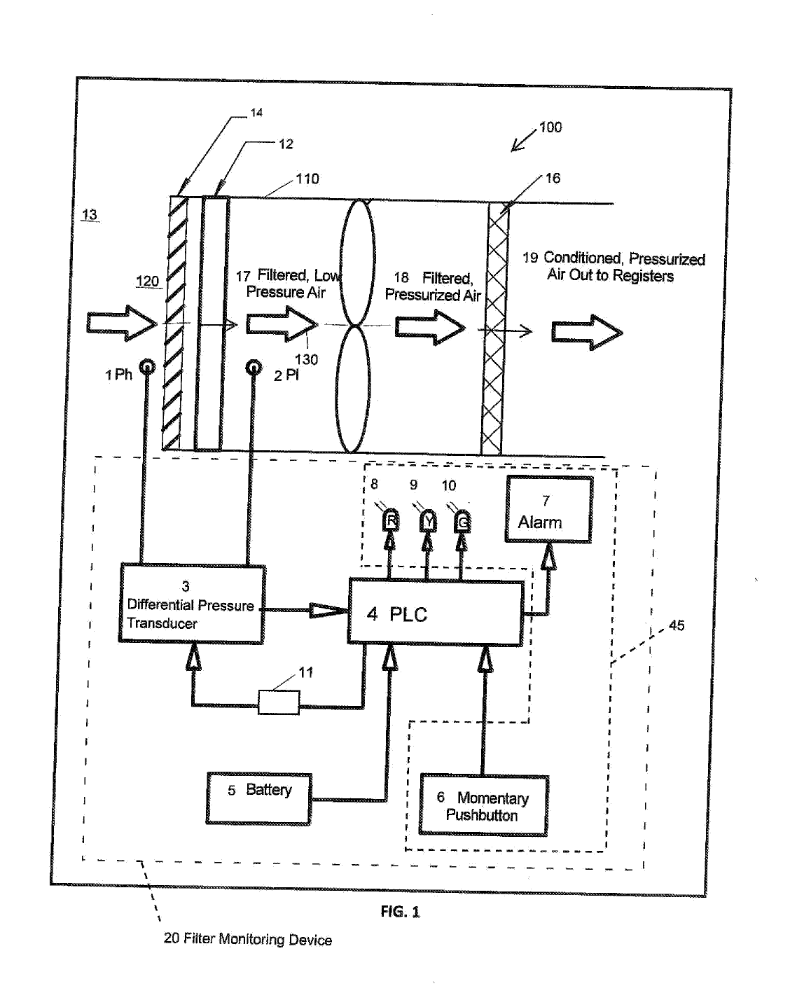

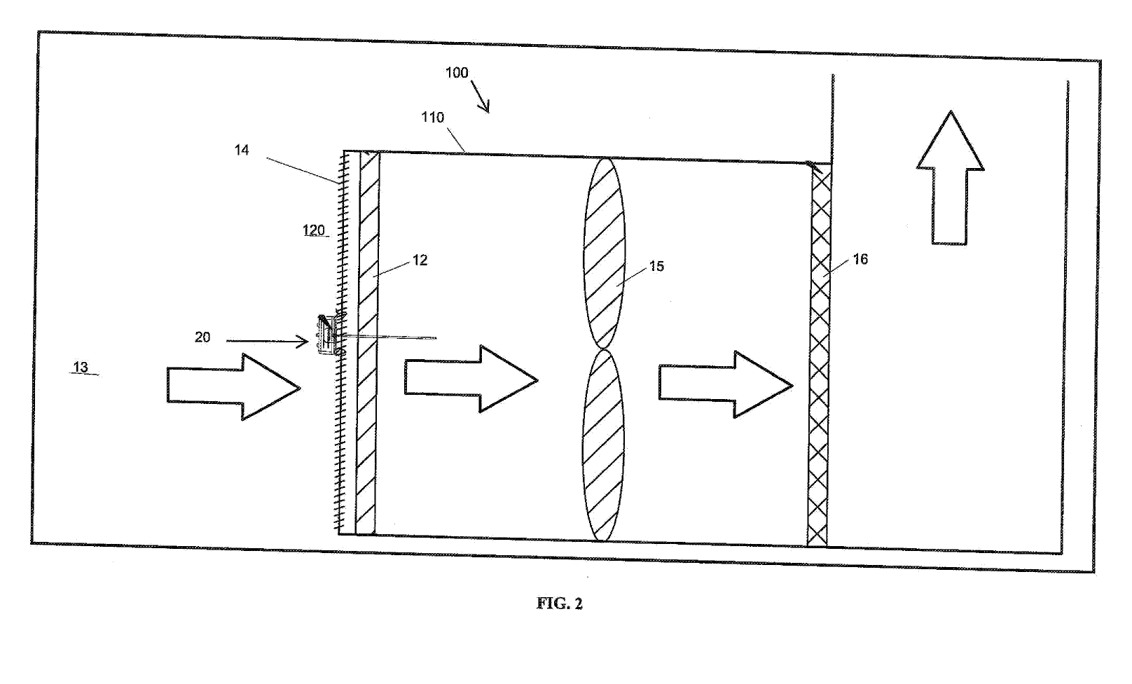

FIGS. 1-7 depict portions of an HVAC system and filter monitoring device 20 embodying various aspects of the invention. FIG. 1 provides a simplified schematic of a filter monitoring device 20 associated with a conventional HVAC system and HVAC air filter 12 in the HVAC system. FIG. 2 depicts an exemplary installation and incorporation of the filter monitoring device 20 with a portion of the HVAC system, namely a conventional air handler 100. The air handler 100 provides duct work 110 that is provided in fluid communication with a conditioned space 13, e.g., a room. The duct work 110 substantially defines a portion of an internal flow stream 13 that may be characterized as originating at an interface or inlet 120 with the conditioned space 13 and extending through the duct work 110. The inlet 120 is also marked by a removable grille 14. The duct work 110 further includes a fan 15 positioned downstream of the inlet 120 within the duct work 110 and a heat exchanger 16 downstream of the fan 15. By way of the inlet 120, the fan 15 draws air from the conditioned space 13 to an air flow stream 130, and directs the air flow through the heat exchanger 16. The HVAC system ultimately returns conditioned air to the conditioned space 13 via various registers (as generally known in the art), After entry through the inlet 120, the air from the conditioned space 13 is initially passed through a porous filter media, i.e., HVAC filter 12, that filters dust, debris and other impurities from the flow stream 130. The filter 12 is of a conventional type and is typically positioned just inside of the grille 14 to facilitate access. Other systems and other embodiments of the invention may, however, allow for or require filter media to be positioned at other points in the flow stream 130 and thus, in other locations in the HVAC system.

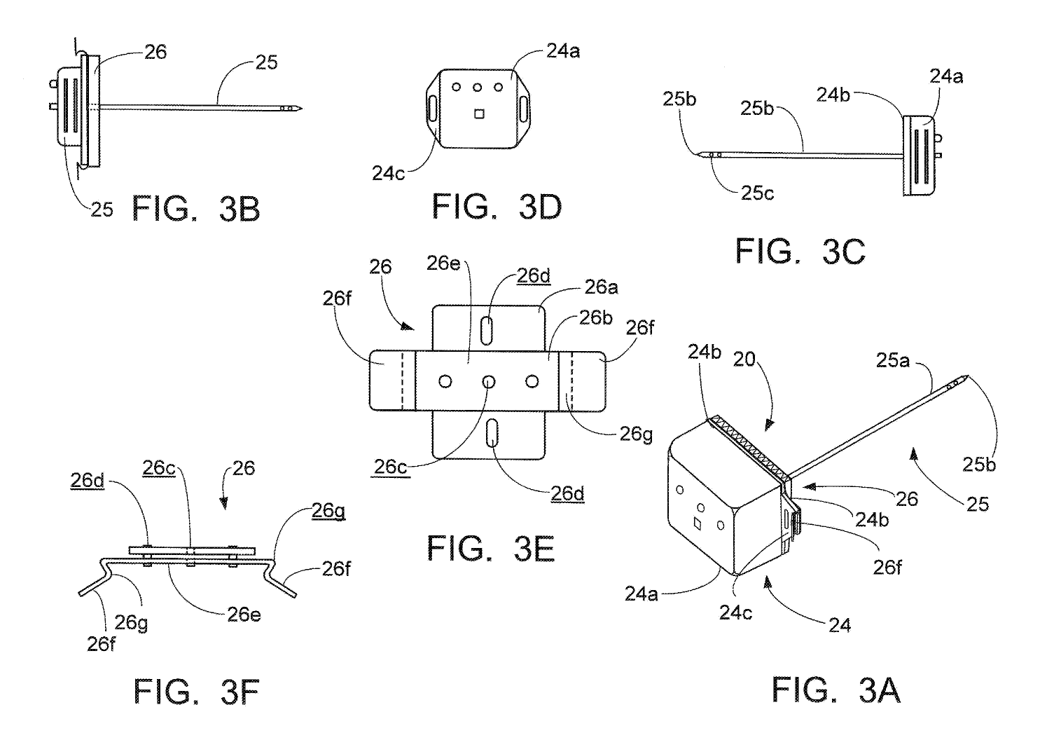

FIGS. 3A-3G provide detailed views of the exemplary filter monitoring device 20 and its various components. In this embodiment, the filter monitoring device 20 includes a compact, lightweight housing 24, an elongated stainless steel probe 25 extending from the housing 24, and a removable mounting assembly or mount 26 detachably engagcable with the housing 24. As will be further discussed below, the housing 24 contains certain control and electronic components, including a differential pressure transducer and battery power source. Referring specifically to FIGS. 3A-3C, the housing 24 also supports the probe 25 and receives information from the probe 25. In this embodiment, the housing 24 includes a relatively low-profile case consisting of a square bowl section 24a and a back plate 24b covering the bowl section 24a. At each of two opposing ends, the back plate 24b has a flange 24c that extends past the rim of the bowl section 24a. As described below, the mount 26 is detachably attachable about the flanges 24c. The probe 25 extends through the back plate 24b and into the bowl section 24a, as best shown in FIG. 3C. The probe 25 consists essentially of a small diameter rod 25a that defines a fluid line or tube (not shown) running centrally therein. The distal end or tip 25b of the probe 25 is made sharp or pointed so as to facilitate insertion of the probe 25 through the filter media. The tube terminates at pressure ports 25c that are located at the circumferential surface of the rod 25a just short of the tip 25b. The distance of the rod 25a (and, thus, the relative position of the ports 25c) is designed to substantially exceed the typical distance from one side of the grille 14 and the other side of media filter 12.

As best shown in FIGS. 3D and 3E, the removable mount 26 is a two-piece metallic construction consisting of a base plate 26a and an elongated clip 26b attached to the base plate 26b. The base plate 26a is a rectangular member having a center hole 26c and a pair of apertures 26d spaced on either side of the center hole 26c. The clip 26b is a thin, flexible metallic member with a flat elongated center 26e and a pair of double-bended ends 26f that taper forwardly away from the center. The double bend forms a curved elbow 26g that can mate with and fit around the flanges 24c of the back plate 24b. The bent configuration lends an inwardly bias to the clip 26b. Accordingly, the bent ends 26f function as “catches” on the mount 26 which can mate with the housing 24 and detachably secure the housing 24 and probe 25 to the mount 26 at a predetermined position relative to the filter 12 and grille 14. The clip 26b may be attached to the base plate 24a by suitable means. As shown in FIG. 3E, the clip 26b is positioned centrally across the base plate 26a in between the apertures 26d of the base plate 26a, and such that the center holes 26c of the base plate 26a and clip 26b align. As illustrated, the probe 25 may be guided and inserted through the center holes 26c to engage the housing 24 with the mount 26.

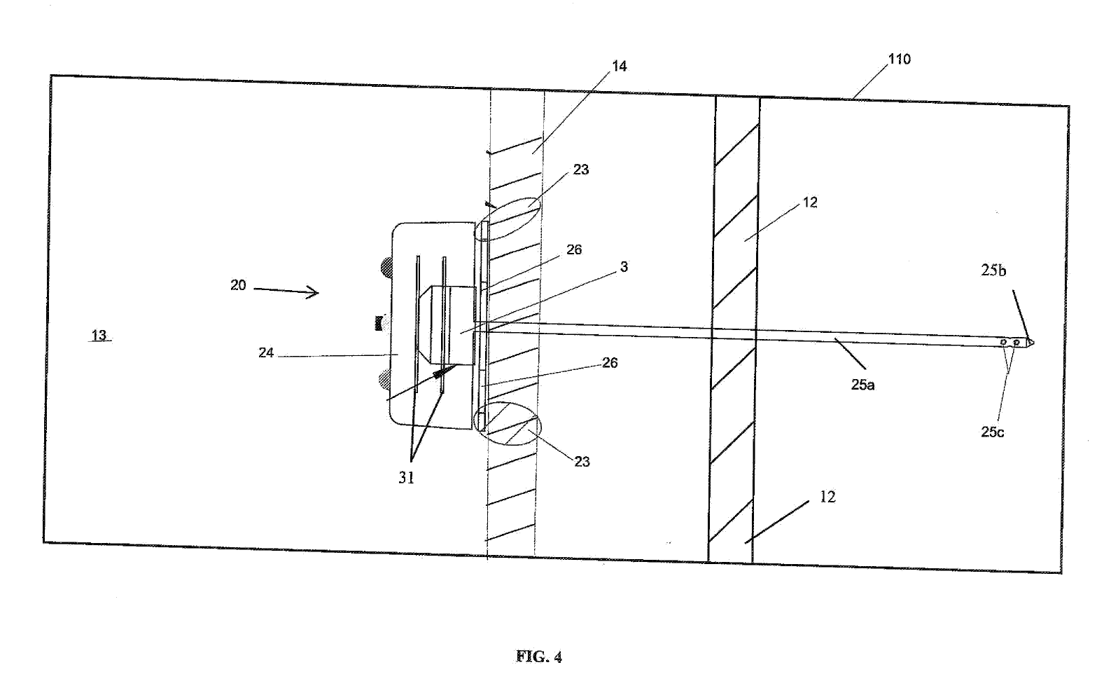

In a suitable installation, the filter monitoring device 20 is secured to, and supported by, the grille 14 at a location preferably central in the flow stream 130. As shown in the detail view of FIG. 4, the housing 24 is directly supported adjacent an upstream side of the grille 14 while the elongated probe 25 extends inwardly through the grille 14 and the air filter 12, to a position downstream of a downstream side of the air filter 12. The pressure sensing port 25b is, therefore, positioned in the flow stream 130 on the downstream side of the air filter 12.

In an initial installation, the mount 26 is brought against the upstream side of the grille 14 (or similarly slatted frame) at the desired or designated location (typically, centrally on the grille). The center holes 26c of the mount 26 indicate the desired position for the probe 25. The mount 26 may be secured to the grill 14 by fasteners 23, such as commercially available “tie wraps,” that are wrapped around the individual slats of the grill 14, as shown in FIG. 4. Toggle bolt and other fasteners may be employed also. The fasteners 23 utilize the apertures 26d on the base plate 26a to firmly secure the mount 26. The housing 24 is then mated with the mount 26 by guiding the probe 25 through the center holes 26d until the back plate flanges 24a engages (catch on to) the clip 26b. In doing so, the probe 25 is also inserted through the filter 12, with the pressure port 25c on the downstream side of the filter 12. The port 25b may be located at a specific distance (or within a range of distances) from the filter 12 on the downstream side so that PI is a location configured to best obtain a representative pressure of air on the downstream side of the filter.

With the mount 26 secured in its designated location, a user can easily, reliably, and repeatedly place the filter monitoring device 20 in operation and in the same position. The housing 24 and probe 25 may be removed, for example, for maintenance (e.g., to replace the battery) or when the air filter 12 is maintained or replaced. The mount 26 may be left stationed on the grille 14 during the maintenance events, however. Thus, when the grille 14 is returned to the inlet 120 or the housing 24 and probe 25 are ready for operation, the housing 24 may be readily returned to their original locations. In this respect, the mount 26 also functions as a permanent base or base mount 20 for the filter monitoring device indicating the predetermined location and position of the component of the filter monitoring device. The mount 26 may also be used in conjunction with other housing/probe units. In any event, the predetermined and/or baseline pressure measuring locations are maintained even when the housing 24 and probe 25 are moved.

Preferably, the clip 26b and flanges 24a are configured so that the housing 24 is not readily disengaged from the mount 26. The stiffness and configuration of the clip 26b may be designed so that the mount 26 cannot be disengaged except with force beyond the capacity of a child. The filter monitoring device 20 is rendered child proof in this respect and cannot be easily removed or tampered.

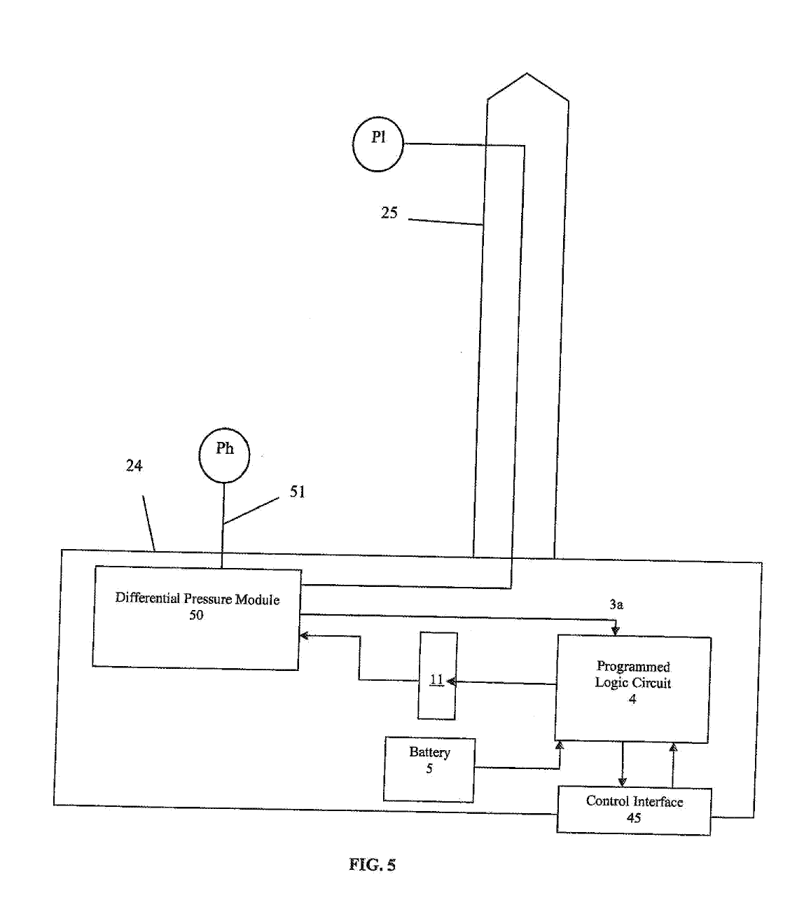

Referring again to FIG. 4 as well as FIG. 2, the bowl section 24a of the housing 24 may be equipped with ports or slits 31 that are open to the conditioned space 13. The slits 31 allow a pressure transducer or equal supported within the case 29 to sense the pressure in the conditioned space 13 (which is equal to the pressure inside the housing 24). Accordingly, as will be further illustrated below, when the filter monitoring device 20 of this embodiment is supported on the grille 14, as shown in FIGS. 2 and 5, the device 20 has the capability of measuring the pressure Ph immediately upstream of the air filter 12 and the pressure P1 immediately downstream of the air filter 12. To obtain the differential pressure across the filter, the filter monitoring device 20 may employ two separate pressure transducers, or more preferably a differential pressure transducer. It should also be noted that in further embodiments, the pressure upstream of the air filter 12 may be assumed as equal to set ambient pressure.

In an embodiment of the invention, the increase in pressure differential across the filter (e.g., due to dirt in the filter) is calculated and stored as a percentage increase. This percentage may be calculated by the formula: DP % increase=(1−DP/DP_{clean filter})×100. The value of DP % increase may be used to determine the degree of filter contamination. For example, if the DP % increase is less than ten percent, the filter may be deemed to be in the acceptable range. If the DP % increase is greater than ten percent, it may be deemed to be either nearly at the end of its useful life or the filter needs to be changed immediately. As shown further below, the system may be equipped with audio and/or visual alarms to correspondingly indicate the instances or conditions.

Referring now to FIG. 1, the housing 24 preferably supports a small battery 5, for example, a 3 volt, 125 ma-hr battery to locally power the filter monitoring device 20. Among other things, the battery 5 supplies power to a differential pressure transducer or meter 3 and a programmable logic circuit such as a microcontroller 4 (PLC) , both of which are also supported within the housing 24. PLC 4 may include a processor (or processor core) and may have an integrated or add-on analog-to-digital converter. One suitable programmed logic circuit 4 is a microcontroller unit manufactured by Microchip (PIC24F08KA101-I/SS). As shown in the schematic of FIG. 1, the PLC 4 reads a signal output of the meter 3. The PLC 4 also communicates with a control interface 45 preferably including LED indicators 8, 9, 10 and a piezo buzzer 7 (or other alert/alarm device). The control interface 45 of the preferred embodiment further includes a momentary pushbutton 6 that provides an input to the PLC 21. These components of the control interface 45 are preferably located on the outside of the bowl section 24a of the housing 24 (see, e.g., FIGS. 3A-3B), and thus, are readily observable and accessible by the user when the filter monitoring device 20 is placed in operation.

To further illustrate the exemplary filter monitoring device, FIG. 5 is provided as a simplified diagram of the various functional modules of the filter monitoring device 20 (wherein like elements are used to indicate like reference numerals). In this embodiment, the housing 24 supports a differential pressure module 50 operatively coupled to a first pressure port 51 in communication with the exterior of the housing 24 (i.e., the ambient environment outside of the grille 14) and a second air pressure port 52 in communication with the exterior of the probe tip 25b (downstream of the air filter 12). The PLC 4 communicates with the differential pressure module 50 and can initiate a measurement mode as well as receive a signal from the module 50. The PLC 4 is powered by battery 5 and communicates with the control interface 45, which is substantially located outside of the housing 24 for interacting with the user. The differential pressure module 50 is adapted (upon receiving electric power), to receive first air pressure signals from the first air pressure port 51 and second air pressure signals from the second port 52, and generate a differential pressure signal 3a representative of a differential pressure value (across the filter).

In accordance with another aspect of the invention, a process for monitoring the air filter entails intermittently powering the differential pressure module 3 through a switchable power circuit 11. More specifically, the differential pressure module 3 is powered only during target events, e.g., measuring event, to assess an operating condition of the filter. At these measuring events, the module 3 takes a differential measurement or reading to be associated with that event or timeframe. In this way, the power consumption of the filter monitoring device is substantially reduced.

In this exemplary embodiment, the LED indicators include red 8, yellow 9, and green 10 LED lamps to indicate various target conditions or status of the air filter or of the filter monitoring device. A red LED indication may be designated for alerting a “damaged filter” condition. A green LED indicator may be used to indicate a “normal filter” operating condition as well as a normal operation mode of the filter monitoring device 20. The piezo buzzer 7 may be programmed to alarm when a primary target condition (i.e., filter requires replacement or approaching such condition). The momentary pushbutton 6 may be used to manually initiate a measurement cycle or to set the baseline differential pressure. For example, when a new filter is installed, the user may press the pushbutton 6 for more than one second. This action by the user generates an initiation signal causing the filter differential pressure to be measured and recorded. This recorded differential pressure is used as the baseline differential pressure. At subsequent readings of differential pressure, the new or measured differential pressure will be subtracted from the recorded or baseline value of the new filter to determine the change in differential pressure across the filter.

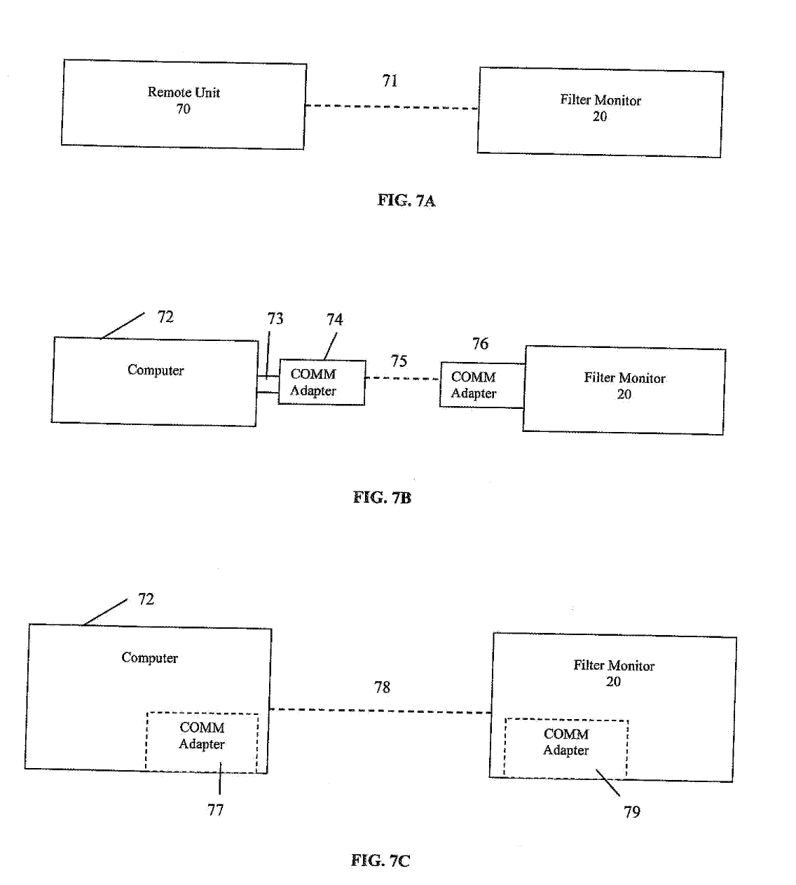

FIGS. 7A-7C show various filter monitor device communications, according to alternative embodiments of the disclosure. In some embodiments, the control interface 45 may include a touch screen, a touchpad, a display, one or more soft keys, or one or more control keys. The control interface 45 may include a separate controller or other interface logic circuits. The control interface may include a remote unit 70 operatively coupled to the filter monitor by wireless communications 71, as shown in FIG. 7A.

The control interface may also be implemented as one or more communications adapters configured to enable communications with a computer. The communications adapter(s) may include a wireless transceiver to effect wireless communications to the filter monitor, a computer, or any other device or service as will occur to those of skill in the art. Wireless communications, as defined herein, may include communications implemented according to protocols compliant with Institute of Electrical and Electronics Engineers (‘IEEE’) 802.11, IEEE 802.16, Zigbee (IEEE) 802.154, or Bluetooth standards, cellular telephony protocols, or any other radio frequency communication as will occur to those of skill in the art.

FIG. 7B illustrates a filter monitor 20 coupled to a computer 72. The filter monitor 20 comprises a monitor-side communications adapter 76 coupled through wireless communications 75 with a computer-side communications adapter 74. The computer-side communications adapter 74 is coupled to the computer 72 through a peripheral connection 73, such as Universal Serial Bus (‘USB’), IEEE 1394 interface, parallel connections, and so on. FIG. 7C illustrates a filter monitor 20 and computer 72 coupled through wireless communications 78 enabled by internal communications adapter 77 in the. computer 72 and internal communications adapter 79 in the filter monitor 20.

In further embodiments, the filter monitor may be integrated as an element in any one of several commonly known wired or wireless network topologies. The network may incorporate a plurality of filter monitors positioned at various locations relative to a filter media and/or various locations throughout an HVAC system. The various filter monitors may be coupled in communication with computers, smart phones, and other electronic controllers and devices. Exemplary types of network topology workable with filter monitors and methods of the invention include the following: ring, mesh (partial), star, mesh (fully connected), line, tree, and bus.

Some embodiments include power-saving technologies enabling very low power drain on the battery. The programmed logic circuits 4 operatively coupled to the other circuits of the air filter monitor 20 may be configured to allow extended operation of the filter monitor in a sleep state, to intermittently wake the filter monitor, and to return the filter monitor to the sleep state. In a sleep state, all processor functions are shut down except an alarm function 32 and an interrupt 31, which is triggered when the pushbutton 6 is depressed. Extended operation may be defined as operation to an extent negating power consumption overhead attributable to non-measurement functions. In some implementations, extended operation may comprise maintaining a ratio of operation in a sleep state to operation in a wake state of at least 10:1. In other implementations, the ratio may be 100:1, 1000:1, or higher. In other implementations, maintaining extended operation may be carried out directly, by adjusting counter variables, interrupt triggers, or timers to take measurements at efficiently distant intervals in light of power consumption in the filter monitor and appropriate sampling intervals to determine filter condition. For example, in a sleep state, the load amperage from the battery is approximately 650 nano-amps, allowing a very long battery life. Note that in the illustrated embodiment, the battery will last over four years.

Measuring intermittently may be carried out by measuring at intervals. The intervals may be regular or irregular. For example, the interval may be defined by a periods of time (by use of a timer, for example), iterations of a routine, a triggering event, a specific number of triggering events, and so on as will occur to those of ordinary skill in the art. In some implementations, the intervals may be varied through the control interface to a desired length.

Aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a module. Embodiments of the invention may be implemented as any viable computing device including logic and memory, or software modules including computer program instructions executed thereon, as will occur to one of ordinary skill in the art, including devices where logic is implemented as field-programmable gate arrays (‘FPGAs’), application-specific integrated circuits (‘ASICs’), and the like.

Aspects of the present invention are described below with reference to flowchart illustrations of methods, devices, and computer program products according to embodiments of the invention. Each block of the flowchart illustrations (or combinations of blocks in the flowchart illustrations) can be implemented by computer program instructions provided to a processor of a special purpose computer or other programmable data processing apparatus for execution to implement the functions specified in the flowchart blocks. These computer program instructions may also be stored in a computer readable medium, such that the instructions stored in the computer readable medium produce an article of manufacture including instructions which implement the functions specified in the flowchart blocks.

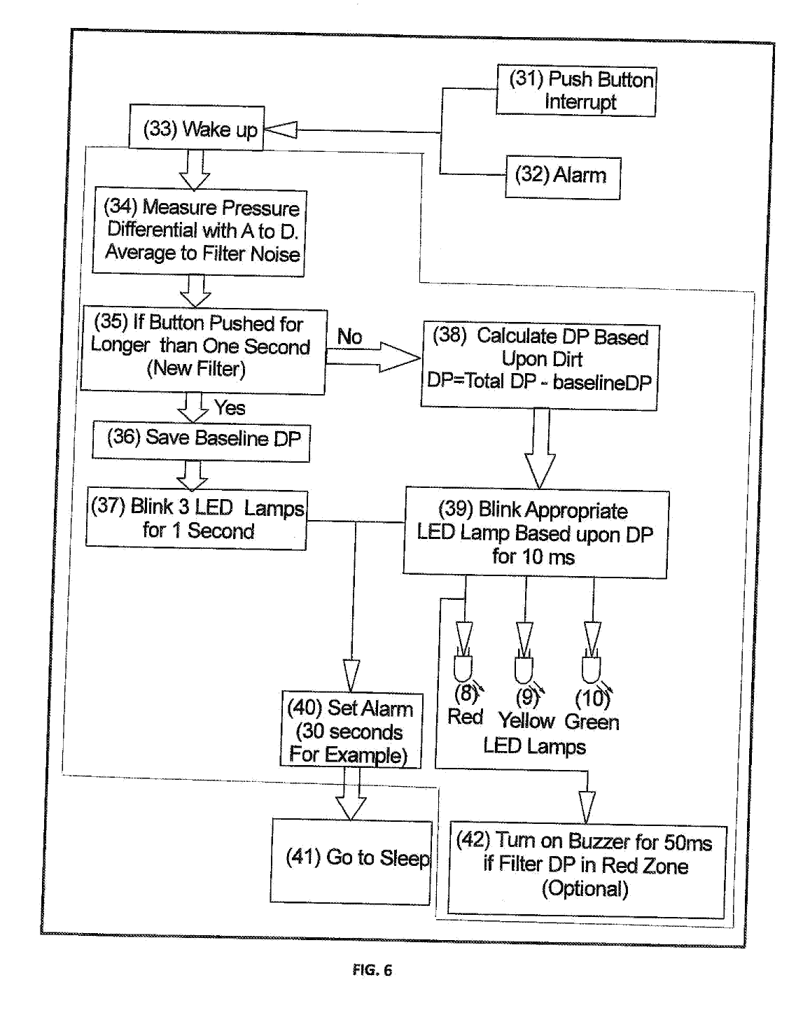

FIG. 6 is a flow chart illustrating exemplary programming modules of the filter monitoring device. Modules include the Wake Up module 33 and the Go to Sleep module 41. The Wake Up module 33 may power up the differential pressure meter 3, measure the differential pressure, and average the measured data to filter out noise 34.

Depending on signals from the control interface, the processor either initiates a configuration mode or remains in a non-configuration (monitoring) mode. In monitoring mode, the device subtracts the baseline differential pressure 36 (which was measured for a new filter with the blower running and stored) from the measured (current) differential pressure 34 to obtain the differential pressure due to impurities accumulated in the filter. The Wake Up module 33 may compare this differential pressure due to impurities to predetermined limits (e.g., threshold values). Upon the differential pressure due to impurities exceeding a threshold value, the Wake Up module 33 indicates a clogged condition associated with the threshold value. if the differential pressure due to impurities fails to exceed a threshold, the Wake Up module may indicate the system is operating nominally or may make no indication. The Wake Up module 33 may blink an appropriate LED lamp based on the differential pressure due to impurities. Next, the device sets the alarm 40 (to 30 seconds, for example), and invokes the Go to Sleep module 41.

The following are some example limits that may be employed in present embodiments:
Acceptable—less than 0.4″ W.C.
Warning—0.4″ to 0.5″ W.C.
Change Required—greater than 0.5″ W.C.

If the device measures a value in the “acceptable” range, the indication includes triggering the green LED lamp 10 to blink for 10 milliseconds. If the device measures a value in the “warning” range, the indication includes triggering the yellow LED lamp to blink for ten milliseconds, and if the device measures a value in the “change required” range, the indication includes triggering the red LED to blink for 10 milliseconds. Additionally or in the alternative, the “change required” condition may trigger turning on the piezo buzzer for 50 milliseconds. In other embodiments, the indication may be carried out according to the particular control interface implemented. For example, indications may include wireless transmissions, generation of text messages or mails, or display of text on a screen coupled to the monitor indicating the current differential pressure, the differential pressure due to impurities, the condition, and so on.

An interrupt 31, (for example, generated in response to depression of the pushbutton 6 for less than 1 second) will cause the unit to wake up and cany out the Wake Up module described above. If the pushbutton is depressed for more than one second 35, then the unit enters the configuration mode, which carries out a baseline zeroing process. This process begins by saving the measured baseline filter differential pressure 36. This baseline differential pressure 36 is used to calculate the differential pressure due to impurities as described above. After the baseline differential pressure 36 is saved, the system triggers an indication that the zeroing process is complete, such as, for example, the three LED lights turning on for one second.

The Change Required condition may optionally be latched (when triggered by a high differential pressure condition due to a clogged filter) so that the indicator will blink red and the buzzer will continue to sound, even if the blower is not running. This latched condition may be reset by depressing the pushbutton 6 for more than one second and entering the configuration mode.

In an alternative method or approach to monitoring a filter according to the invention, a voltage measurement for the differential pressure transducer voltage is recorded at a system start-up. Such a start-up event may coincide with initial programming of the PLC or battery insertion. More specifically, the voltage reading for the differential pressure transducer (3) voltage is initially measured with zero pressure differential applied to the differential pressure transducer (4). This voltage reading, V₀, (or other measurement) is set to correspond to an initial differential pressure setting, P0. This action eliminates piece to piece manufacturing variances of the differential pressure transducer and the voltage measurement circuitry in the PLC (4). Then, upon installation of a clean filter, a baseline pressure differential (P_{clean}) across the clean filter is measured and recorded. The measurement may be preferred at start-up of the HVAC system. With the fixed settings of the system in place, the system commences intermittent or powering savings mode whereby the system measures the operating condition at designated wakeup events.

At wakeup, the filter pressure differential (P_{filter}) is measured and compared to the initial and system settings. In this exemplary method, the pressure differential increase or change (Pᵣₐₜᵢₒ) is preferably calculated using the formula, Pᵣₐₜᵢₒ=(P_{filter}−P_{zero})/(P_{clean}−P_{zero}), where P_{zero} and P_{clean} are the initial settings. This value, Pᵣₐₜᵢₒ, is, of course, reflective of the change in the condition of the filter media since system start-up. For example, if the maximum acceptable pressure differential increase ratio (Pₐₗₐᵣₘ) is set at 2 or twice the differential pressure at system start-up (i.e., based upon filter manufacturer's recommendation), a continuous indication of the filter condition may be presented using the following formula:

Clog % (0 to 100%)=((Pᵣₐₜᵢₒ−1)/(Pₐₗₐᵣₘ−1)×100. (0 to 100%)

At a condition of Clog % equal to 100%, the differential pressure across the filter media has doubled since system start-up and the

Furthermore, the degree of clogging may be displayed via the 3 LEDs (green, yellow, red). PLC setpoints and LED indications may be established, for example, at the following: (1) Clog % less than 75%, Green; (2) Clog % greater than 75%, Yellow; and (3) Clog % greater than 100%, Red. An alternative mode of displaying the degree of clogging may be achieved through use of a series of indicator lamps (i.e., as a bar graph) with corresponding trigger values. The amount or degree of clogging may also be presented as a numeric number on an LCD display.

Another advantage to this ratio approach is that less accurate differential pressure transducers can be used because the calculations depend upon differential pressure ratios. The absolute value of the pressure differential is not required. Thus, non-calibrated pressure transducers maybe sued, provided the transducer outputs are linear with differential pressure.

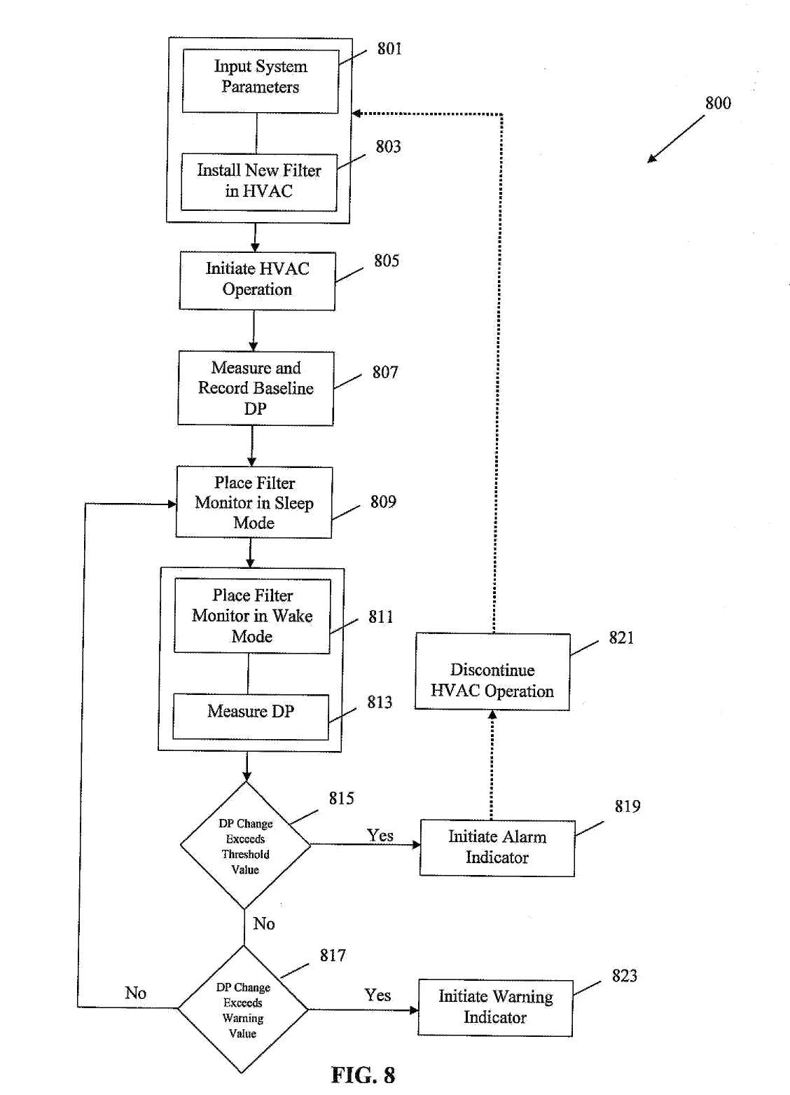

FIG. 8 provides a simplified process diagram illustrating an exemplary, but basic, method of monitoring filter media in an HVAC system (800) according to the invention. This exemplary method (800) may utilize the various functional modules of the filtering monitoring device in FIGS. 5 and 6. The exemplary method (800) involves operating the differential power module intermittently and placing it in a reduced or zero-power mode (the Sleep Mode) to conserve battery power. In a first step or stage of the process, system parameters may be inputted into the filter monitoring device via the PLC (801). Input parameters may include alarm and warning settings for a change in differential value, as well as an initial or zero differential pressure value for the pressure module. This input step (801) may be followed by or coincide with the installation of a new filter in the HVAC system (803). After initiating operation of the HVAC system (805), the differential pressure module registers differential pressure readings across the filter. A baseline differential pressure value is then measured and recorded (807). This differential pressure value corresponds with the differential pressure associated with a fresh filter during normal or predetermined HVAC air flow.

With the filter monitoring device in place and storing initial values and system parameters, the filter monitoring sub-process commences. As mentioned above, it is desirable for the differential pressure module, or perhaps, other non-critical modules, to be powered down to at least a reduced power state if not shut down mode. In this exemplary method (800), the differential pressure module is powered down immediately after the baseline differential pressure is recorded and the filter monitor is then described as being placed in Sleep Mode (809). The filter monitor may be maintained in this Sleep Mode for pre-determined durations and/or until, the occurrence or indication of certain system events (e.g., HVAC start-up). In any case, the differential pressure module is eventually powered back up and the filter monitor placed in Wake Mode (811). In Wake Mode, a differential pressure measurement is made and recorded (813), thereby updating the status or condition of the filter.

With a new or current differential pressure value inputted into the PLC, the system calculates the change in the differential pressure across the filter. This calculation is performed by comparing the current differential pressure value with the baseline value (or in alternative ways as explained herein). In this exemplary method (800), the PLC makes a determination whether this calculated change exceeds the predetermined threshold value (e.g., indicative of a clogged filter) (815). If a positive determination is made, the PLC initiates a preferred alarm indicator (819), which may be a visual alarm (e.g., a red LED, strobe) and/or an audio alarm. In this exemplary method (800), operating procedures may dictate that operation of the HVAC system is discontinued (821) (by the user or maintenance personnel rather than automatically) so that the HVAC system is checked out. If indeed, the filter is clogged or otherwise unacceptable, a new filter is installed (see 803). If the calculated change in differential pressure does not exceed the threshold value, the PLC tests whether the calculated change exceeds an intermediate or warning value (817). Typically, this lower value is set to indicate that the differential pressure change is nearing the threshold value and that the filter condition is nearing a clog condition. In this exemplary method (800), the PLC initiates a warning indicator (e.g., a yellow LED) (823) if a positive determination is made. If a positive determination is not made, however, the filer monitor is returned to Sleep Mode with the HVAC system maintaining normal operation (see 809). The filter monitoring sub-process continues with the next event triggering placement of the filter monitor in the Wake Mode. For some applications, operating procedures may dictate replacement of the filter anyway, as for example, if the HVAC system is undergoing scheduled maintenance.

Embodiments of the present invention include design structures. Such embodiments may be contained on one or more machine readable media as a text file or a graphical representation of hardware embodiments of the invention. Typically, planning design structures are provided as input to design processes used in semiconductor design, manufacture, and/or test, to generate manufacturing design structures, with the exact processes used depending on the type of integrated circuit (‘IC’) being designed, such as an application specific IC (‘ASIC’), a standard component, and so on. A first design structure may be input from an IP provider, core developer, or any other source. A first design structure may include an embodiment of the invention in the form of schematics or a hardware-description language (‘HDL’), e,g., Verilog, VHDL, C, etc. Design processes may be used to translate an embodiment of the invention (for example, as shown in FIG. 1) into a netlist, e.g., a list of wires, transistors, logic gates, control circuits, I/O, models, and so on. These processes may employ automation tools and applications, and may include inputs from a library which may house a set of commonly used elements, circuits, and devices, including models, layouts, and symbolic representations. The netlist describes the connections to other elements and circuits in an IC design, and may also be disposed on a machine readable medium. A netlist may be composed iteratively depending on design specifications and parameters for the circuit.

The design process may translate a planning design structure into a manufacturing design structure that resides on a storage medium in a data format used for the exchange of layout data of integrated circuits (for example, data stored in a GDSII (GDS2), GL1, OASIS, or any other suitable manufacturing design structure format). The manufacturing design structure may comprise information such as, for example, test data files, design content files, manufacturing data, layout parameters, wires, levels of metal, vias, shapes, or any other data required by a semiconductor manufacturer to produce a hardware embodiment of the invention. A producer may then employ the manufacturing design structure in tape-out and manufacture.

The discussion above has focused primarily on embodiments of the invention for use with HVAC systems. Other embodiments may be used with other filtration systems. It should be understood that the inventive concepts disclosed herein are capable of modifications. Such modifications may include combinations of hardware and software embodiments, specific circuit designs, combinations of circuits into an IC, separation of an IC into various components, and so on. The discussion above has focused primarily on embodiments of the invention having a differential pressure transducer for measurement, providing interaction through a simple interface, and controlled by a microprocessor. Modifications may include modifications in the type of control interfaces, the measurement tools and their configurations used to determine a differential pressure, and the implementation of the control methods described above. To the extent such modifications fall within the scope of the appended claims and their equivalents, they are intended to be covered by this patent.

What is claimed is:

1. An apparatus for monitoring a pressure differential across an air filter in a given internal flow stream, the flow stream having a grille frame positioned upstream of the filter, the apparatus comprising:
a pressure sensing module for providing a differential pressure measurement across filter media of the air filter;
a housing supporting the pressure sensing module;
a pressure sensing probe in communication with the pressure sensing module, the probe including an elongated probe body adapted for insertion through a filter media and having a pressure sensing port therethrough, the probe being supported by the housing such that the probe body extends from inside the housing outwardly to a distal end; and
a base mount positionable on a grille frame upstream of the air filter, the housing being detachably engageable with the base mount to place the probe body in fluid communication with a pressure sensing location spaced from the opposite side of the base mount.

2. The apparatus of claim 1, wherein the base mount further includes retainer means for detachably engaging the housing and the base mount in a mutually engaged position such that the probe body is placed in a predetermined position relative to the base mount.

3. The apparatus of claim 2, wherein the base mount includes a guide way for passing the probe body through the base mount and the grille frame to detachably engage the housing with the base mount.

4. The apparatus of claim 3, wherein the guide way includes an aperture adapted to accommodate the probe body therethrough such that the probe body is passable therethrough to guide the housing into mutual engagement with the base mount.

5. The apparatus of claim 4, wherein the probe body extends outwardly from a back wall of the housing, and wherein the back wall is detachably engageable with the base mount such that the probe body is directed through the base mount in the mutually engaged position of the housing and the base mount.

6. The apparatus of claim 2, further comprising a battery source supported within the housing, a control module for communicating with the sensor module, and a control interface for indicating detection of a target change in differential pressure across the filter.

7. The apparatus of claim 2, wherein the base mount includes one or more apertures on the base mount for tethering the base mount.

8. The apparatus of claim 2, wherein the retainer means include a pair of catches and the housing includes a pair of flanges mateable with the catches to detachably retain the housing in mutual engagement with the base mount.

9. The apparatus of claim 1, wherein the pressure sensing module includes a differential pressure transducer.

10. The apparatus of claim 9, further comprising:
a battery;
a switchable power circuit for switchably delivering electric power from the battery to the pressure sensing module;
a control interface;
a programmed logic circuit operatively connected with the switchable power circuit, the differential pressure transducer, and the control interface, the programmed logic circuit adapted to:
intermittently power up the pressure sensing module from a sleep state for a measurement including activating the switchable power circuit, and power down the pressure sensing module to the sleep state following the measurement including deactivating the switchable power circuit;
receive the differential pressure signal;
determine a current differential pressure value from the differential pressure signal; and
if the apparatus is operating in a configuration mode, store the current differential pressure value as a baseline value; and
if the apparatus is operating in a monitoring mode, calculate a difference between the baseline value and the current differential pressure value, and, upon the difference exceeding a threshold value, indicate a target condition corresponding to the threshold value through the control interface.

11. The apparatus of claim 9, further comprising:
a battery;
a switchable power circuit for switchably delivering electric power from the battery to the differential pressure transducer;
a wake circuit adapted to intermittently power up the apparatus from a sleep state for a measurement including activating the switchable power circuit, and power down the apparatus to the sleep state following the measurement including deactivating the switchable power circuit;
a control interface;
a programmed logic circuit operatively connected with the switchable power circuit, the differential pressure transducer, and the control interface, the programmed logic circuit adapted to:
receive the differential pressure signal;
determine a current differential pressure value from the differential pressure signal; and
if the apparatus is operating in a configuration mode, store the current differential pressure value as a baseline value; and
if the apparatus is operating in a monitoring mode, calculate a difference between the baseline value and the current differential pressure value, and, upon the difference exceeding a threshold value, indicate a target condition corresponding to the threshold value through the control interface.

12. A method of monitoring an air filter with a battery-powered filter monitor, the filter filtering intake air flowing from an upstream to a downstream side of the filter, the method comprising:
determining with the filter monitor a first pressure measurement indicative of a pressure differential across the filter;
setting a baseline value at the first pressure measurement and a threshold value corresponding to a target change in differential pressure;
initiating a sleep state of the filter monitor, whereby the power requirement of the filter monitor is at least reduced from that of a normal measuring state;
operating the filter monitor in a sleep state;
intermittently waking the filter monitor, including:
powering up the filter monitor to a wake state, whereby the power requirement of the filter monitor is returned to a normal measuring state;
determining with the filter monitor a second pressure measurement indicative of a second pressure differential across the filter;
determining the difference between the second pressure measurement and the baseline value; and
upon the difference between the second pressure measurement and the baseline value exceeding the threshold value, indicating a target condition associated with the threshold value; and
upon the difference between the second pressure movement and the baseline value not exceeding the threshold value, repeating the initiating, operating, and intermittently waking steps.

13. The method of claim 12, wherein determining with the first pressure measurement includes measuring a first air pressure upstream of the filter and measuring the second air pressure downstream of the filter.

14. An air filter assembly in an HVAC system, the air filter assembly comprising:
an air filter positioned in the HVAC system in the path of an internal flow stream; and
a filter monitoring device positioned upstream of the air filter, the device including,
a pressure sensing module for providing a differential pressure measurement indicative of differential pressure across the filter;
a housing supporting the pressure sensing module; and
a pressure sensing probe in communication with the pressure sensing module, the probe including an elongated probe body extending from an upstream side of the filter to a downstream side of the filter, the probe body having a pressure sensing port therethrough, the probe being supported by the housing such that the probe body extends from inside the housing outwardly to a distal end on the downstream side of the filter; and
wherein the pressure sensing module is in further fluid communication with the upstream side of the filter via the housing to provide a second pressure sensing port.

15. The air filter assembly of claim 14, further comprising:
a battery;
a switchable power circuit for switchably delivering electric power from the battery to the pressure sensing module;
a control interface; and
a programmed logic circuit operatively connected with the switchable power circuit, the pressure sensing module, and the control interface, the programmed logic circuit being adapted to:
intermittently power up the pressure sensing module from a sleep state for a measurement including activating the switchable power circuit, and power down the pressure sensing module to the sleep state following the measurement including deactivating the switchable power circuit;
receive first differential pressure signals form the pressure sensing module;
determine a current differential pressure value from the differential pressure signals;
if the apparatus is operating in a configuration mode, store the current differential pressure value as a baseline value; and
if the apparatus is operating in a monitoring mode, calculate a difference between the baseline value and the current differential pressure value, and, upon the difference exceeding a threshold value, indicate a target condition corresponding to the threshold value through the control interface.

16. The air filter assembly of claim 14, further comprising:
a programmable logic circuit operatively connected with the pressure sensing module, and
a battery providing power to the programmable logic circuit; and
wherein the pressure sensing module includes a differential pressure transducer operatively connected with the programmable logic circuit; and
wherein the differential transducer, the programmable logic circuit, and the battery are supported within the housing, the second sensing port of the differential pressure being located in fluid communication with an exterior of the housing.

17. The air filter assembly of claim 14, further comprising:
a grille frame spaced from the filter on an upstream side of the filter; and
a base mount detachably secured to the grille frame, wherein the base mount further includes retainer means for detachably engaging the housing with the base mount such that the probe body is placed in a predetermined position relative to the base mount and the housing, and the probe body extends through the filter a pressure sensing location to downstream of the filter.

18. The air filter assembly of claim 17, wherein the base mount includes a guide way passing the probe body through the base mount and the grille frame, and
the guide way includes an aperture accommodating the probe body therethrough such that the probe body is slidably engageable therewith to guide the housing into engagement with the base mount.

19. The air filter assembly of claim 18, wherein the housing includes a control interface, the control interface including at least one visual indicator supported on the housing and operatively connected with the programmable logic circuit, and a control push button operatively connected with the programmable logic controller.

20. A method of monitoring filter media in an HVAC system, wherein an inlet to an internal flow stream of the HVAC system from a conditioned space is defined by a grille frame, the method comprising:
providing a filter monitoring device having:
a pressure sensing module for measuring a differential pressure across filter media;
a housing supporting the pressure sensing module;
a pressure sensing probe in communication with the pressure sensing module, the probe including an elongated probe body adapted for insertion through the filter media and having a pressure sensing port therethrough, the probe being supported by the housing such that the probe body extends from inside the housing outwardly to a distal end;
a base mount fastenable to the grille frame;
positioning an air filter in the HVAC system spaced from and downstream of the grille frame;
securing the base mount to the grille frame on an upstream side of the grille frame and in the conditioned space;
engaging the housing with the base mount such that the housing is detachably supported by the base mount and the pressure sensing probe is inserted through the grille frame and the filter media of the filter and past a downstream side of the filter; and
measuring the differential pressure across the filter media with the pressure sensing module, including determining a pressure measurement with the pressure sensing port in fluid communication with the downstream side of the filter.

21. The method of claim 20, wherein the pressure sensing module includes a differential pressure transducer located in the housing, the measuring step including using the differential pressure transducer to measure the differential pressure difference from upstream of the filter about the housing and at the sensing port of the probe body.

22. The method of claim 21, farther comprising:
after the measurement step, recording the differential pressure measurement as a baseline value;
after continued operation of the HVAC system with the air filter, conducting a post-filter installation measurement step to find a current differential pressure across the filter media;
calculating the change in the differential pressure across the filter from the baseline value and the current differential pressure; and
comparing the calculated change in the differential pressure with a threshold value.

23. The method of claim 22, further comprising:
disengaging the housing and the base mount from a mutually engaged position, thereby removing the probe from communication with a pressure sensing location downstream of the filter while maintaining the base mount secured to the grille frame;
re-engaging the housing and the base mount in the mutually engaged position, thereby returning the probe in fluid communication with the pressure sensing location downstream of the filter; and
repeating the post-filter installation measurement step, the calculating step, and the comparing step to determine a subsequent change in differential pressure across the filter.

24. The method of claim 23, further comprising the step of, upon determining a calculated change in differential pressure exceeding the threshold value, initiating an alert indicator.
